(19) United States
(12) Patent Application Publication
(10) Pub. No.: US 2022/0196202 A1
(43) Pub. Date: Jun. 23, 2022

(54) Vertical Dual Microphone Stand

(71) Applicant: Ryan Taurosa, Allenwood, NJ (US)

(72) Inventor: Ryan Taurosa, Allenwood, NJ (US)

(21) Appl. No.: 17/125,260

(22) Filed: Dec. 17, 2020

(51) Int. Cl. F16M 11/28; F16M 11/04

(52) U.S. Cl. CPC F16M 11/28; F16M 11/046; F16M 11/045

(57) ABSTRACT

A vertical dual microphone stand is a single column microphone stand configured for the attachment of at least two microphones, wherein the positioning of the microphones is independently adjustable in the vertical and horizontal position.

### BACKGROUND

### 1. Field

One or more embodiments of the present invention relate to a single column microphone stand comprising at least two microphone holders, permitting at least two microphones to be attached to a single vertical stand. It is envisaged that the topmost microphone holder would be used to amplify vocals, whereas the lowermost microphone holder would be used to amplify the sound of a musical instrument. Both microphone holders are independently adjustable for the most precise alignment with the vocals and the musical instrument.

### 2. Description of the Related Art

Conventional microphone stands are typically configured to hold one or more microphones in a horizontal plane only. Common microphone stands known in the art rely on a base to adjust the position of the attached microphones and the use of multiple separate microphone stand columns. As disclosed in U.S. Pat. No. 4,449,020, this concept incorporates at least three separate pieces and relies on pivot movement in a forward and backwards motion, which does not permit the user to customize the position of the microphones in accordance with the user's vertical position, as both microphones must be adjusted separately. Further, the base of the unit is heavy (contains cast iron for stability) and difficult to transport. Also, as previously indicated, the prior art microphone stands involve at least 3 separate components that are limited in adjustment range, which does not allow for the most optimum amplification of vocals and instruments.

Another example of a prior art microphone stand is disclosed in U.S. Pat. No. 6,663,060. The stand of the '060 patent only allows for the adjustment of the microphone stand height, and not for vertical and horizontal repositioning of the microphone.

Many currently marketed microphone stands are of the “boom arm” type, which rely on a “boom” stick/arm attached to a microphone stand. This design suffers from unequal weight distribution resulting in the microphone stand falling over when the microphone arm is positioned at certain angles. Also, the boom arm protrudes far out in front of or behind the column support consuming extra unnecessary space. Lastly, optimal adjustment of the boom arm is difficult because the arm is always at an angle to the support arm.

Therefore, what is needed is a single column microphone stand that allows for the attachment of at least two microphones permitting the user to customize the position of each attached microphone independently.

### SUMMARY

In view of what is known in the art, the inventor has developed a single column microphone stand that overcomes the aforementioned disadvantages. The present single column microphone stand comprises at least two microphone holders, permitting at least two microphones to be attached to a single vertical stand. The present vertical microphone stand allows the user to customize the positioning of each microphone independently. The microphones may be adjusted vertically and horizontally independently or as an entire unit.

### BRIEF DESCRIPTION OF THE DRAWINGS

These and/or other aspects will become apparent and more readily appreciated from the following description of the embodiments, taken in conjunction with the accompanying drawings in which:

FIG. 1 is a drawing of the vertical microphone stand with two microphones attached thereto.

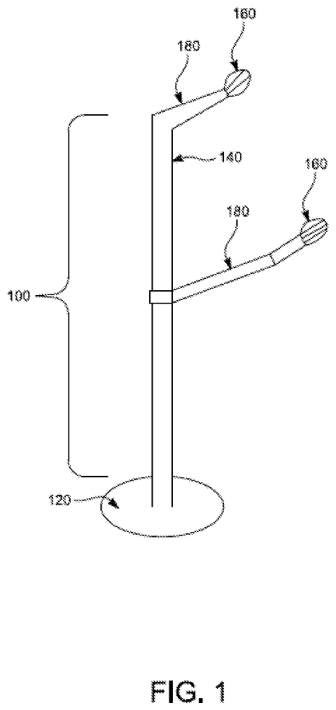

### DETAILED DESCRIPTION

Reference will now be made in detail to embodiments, examples of which are illustrated in the accompanying drawings. In this regard, the present embodiments may have different forms and should not be construed as being limited to the descriptions set forth herein. Accordingly, the embodiments are merely described below, by referring to the figures, to explain aspects of the present invention.

The vertical dual microphone stand (100) is a single column microphone stand configured for the attachment of at least two microphones, wherein the positioning of the microphones is independently adjustable in the vertical and horizontal position.

The microphone stand (100) comprises an apparatus comprising a base (120) with a support (140) attached thereto. The base may be any type of structure that may allow a longitudinal support (180) to be placed upright and which may support microphone holders. At least two microphone holders (160) are secured to the support attached to the base. The microphone holders are any suitable microphone holders that are configured to attach to the support of the microphone stand (100).

The support may be elongated cylindrical shafts, that are hollow, solid, or combinations thereof. The support may be any geometric shape that is suitable for the attachment of at least two microphone holders (180). The stand is adjustable in the horizontal plane by means of a suitable mechanism inside the support. The mechanism allows for the release of the adjustable support for repositioning and a means for securing the support once the optimum positioning is achieved.

The microphone holders (160) may be any type of longitudinal axial element that is configured to hold a microphone and may be attached to the support of the present microphone stand. The holder may comprise a clip, grip, or mount configured to hold standard microphones and a clip, grip or mount for attachment to the support of the stand.

The microphone holders (160) are adjustable in the horizontal and vertical planes. The at least two microphone holders may be adjusted vertically as a unit or independently. The means for adjusting the microphone holder in the horizontal position may be any suitable mechanism for releasing and securing the microphone in the holder. The means for adjusting the microphone holder in the vertical position may be any suitable mechanism for releasing and securing the microphone holder along the support of the microphone stand.

The foregoing descriptions of specific embodiments of the present invention have been presented for purposes of illustration and description. They are not intended to be exhaustive or to limit the invention and method of use to the precise forms disclosed. It is understood that many modifications and variations are possible in light of the above teaching. The embodiment was chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

In one exemplary embodiment, the present vertical microphone stand (100) is an apparatus comprising a base (120); a support (140); and at least two microphone holders (160) attached to the support (140). The support (140) is adjustable in the vertical plane. The microphone holders (160) are adjustable in the vertical and horizontal planes.

1. A vertical microphone stand comprising an apparatus wherein the apparatus comprises a base; a support; and at least two microphone holders attached to the support.

2. The vertical microphone stand of claim 1 wherein the support is adjustable in the vertical position.

3. The vertical microphone stand of claim 1 wherein the at least two microphone holders are adjustable in the vertical and horizontal planes.

4. The at least two microphone holders of claim 3 wherein the vertical adjustment of the two or more holders can occur independently or as a single unit.
